(19) United States
(12) Patent Application Publication
(10) Pub. No.: US 2019/0297371 A1
(43) Pub. Date: Sep. 26, 2019

(54) METHOD AND A SYSTEM FOR NETWORK BASED MULTIMEDIA CONTENT RECORDING IN A CLOUD

(71) Applicant: WIPRO LIMITED, Bangalore (IN)

(72) Inventors: Gowrishankar Subramaniam Natarajan, Chennai (IN); Sayar Banerji, Bangalore (IN)

(73) Assignee: Wipro Limited

(21) Appl. No.: 15/937,018

(22) Filed: Mar. 27, 2018

(30) Foreign Application Priority Data
Mar. 20, 2018 (IN) 201841010178

(51) Int. Cl. H04N 21/2747; H04N 21/258; H04N 21/25; H04N 21/239; H04N 21/647

(52) U.S. Cl. CPC H04N 21/2747; H04N 21/25866; H04N 21/252; H04N 21/64738; H04N 21/64769; H04N 21/25841; H04N 21/2393

(57) ABSTRACT

A method and a system are described for a cloud enabled multimedia content recording. The method includes receiving a recording request from a user for recording multimedia content, wherein the recording request comprises one or more attributes. The method includes determining one or more attribute values associated with the recording request. The method includes comparing the one or more attribute values associated with the recording request with historical attribute values associated with a plurality of multimedia content previously viewed by the user to determine one or more viewership patterns. The method includes determining one or more preferred bit rates based on determining the one or more viewership patterns. The method includes recording the multimedia content at the one or more preferred bit rates.

### TECHNICAL FIELD

The present subject matter is related, in general to digital video recording and more specifically, but not exclusively to a method and a system for network based multimedia content recording in a cloud.

### BACKGROUND

The digital age has moved away from multimedia content being streamed on user devices where the user has access to the multimedia content during steaming of the content. Multimedia content in the present scenario may be saved on the user's electronic device or may be saved remotely, say for example, a cloud for future consumption. However, when saving or recording multimedia content on a cloud, a user must understand what to save, when to save and how much to save. This in turn reduces the efficiency of managing data in the cloud.

With the advent of Over the content (OTT), IP & mobile networks, next generation video services such as Cloud DVR have become increasingly popular across the globe. It provides consumers with the ability to watch a favorite video when they want to watch, wherever they want to watch and on the device that they like to watch. Storage in the cloud, albeit cheap, becomes a major cost driver where typical storage provisioning per user can be as high as 1.5-2 TB, considering that the user stores 100 hours of video in the cloud in 7-8 bit rate profiles that the user typically watches on mobile and broadband networks. The storage required may further increase if higher order bit rate profiles for HD and 4K content are supported. This is due to the fact that all the video bit rate profiles have to be stored when user initiates a recording in the cloud, because Cloud DVR systems today are not aware of the type of network, device and bit rate profile that would be requested by the client during playback of the recording. This results in increased storage costs in public/private clouds and inefficient storage management of recorded video content since the user may not play back all the video bit rate profiles.

### SUMMARY

The foregoing summary is illustrative only and is not intended to be in any way limiting. In addition to the illustrative aspects, embodiments, and features described above, further aspects, embodiments, and features will become apparent by reference to the drawings and the following detailed description.

According to embodiments illustrated herein, there may be provided a method for network based cloud enabled multimedia content recording. The method may include receiving a recording request for recording multimedia content from a user, wherein the recording request comprises one or more attributes. The method may include determining one or more attribute values associated with the recording request. The method may include comparing the one or more attribute values associated with the recording request with historical attribute values associated with a plurality of multimedia content previously viewed by the user to determine one or more viewership patterns. The method may further include determining one or more preferred bit rates based on determining the one or more viewership patterns. Subsequently, the method may include recording the multimedia content at the one or more preferred bit rates.

According to embodiments illustrated herein, there may be provided a cloud enabled multimedia content recording system for multimedia content recording, comprising a processor and a memory communicatively coupled to the processor, wherein the memory stores processor instructions, which, on execution, causes the processor to receive a plurality of factors associated with a plurality of software modules from a plurality of external systems. The processor may be further configured to receive a recording request for recording multimedia content from a user, wherein the recording request comprises one or more attributes. The processor may be further configured to determine one or more attribute values associated with the recording request. The processor may be further configured to compare the one or more attribute values associated with the recording request with historical attribute values associated with a plurality of multimedia content previously viewed by the user to determine one or more viewership patterns. The processor may be further configured to determine one or more preferred bit rates based on determining the one or more viewership patterns. The processor may be further configured to record the multimedia content at the one or more preferred bit rates.

According to embodiments illustrated herein, a non-transitory computer-readable storage medium having stored thereon, a set of computer-executable instructions for causing a computer comprising one or more processors to perform steps. The one or more processors may be configured to receive a recording request for recording multimedia content from a user, wherein the recording request comprises one or more attributes. The one or more processors may be configured to determine one or more attribute values associated with the recording request. The one or more processors may be configured to compare the one or more attribute values associated with the recording request with historical attribute values associated with a plurality of multimedia content previously viewed by the user to determine one or more viewership patterns. The one or more processors may be configured to determine one or more preferred bit rates based on determining the one or more viewership patterns. The or more processors may be configured to record the multimedia content at the one or more preferred bit rates.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a block diagram of an exemplary environment in which various embodiments of the present disclosure may function.

FIG. 2 illustrates a block diagram of a multimedia content recording system, in accordance with some embodiments of the present disclosure.

FIG. 3 is a flowchart illustrating a method for a network based multimedia content recording in cloud, in accordance with some embodiments of the present disclosure.

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

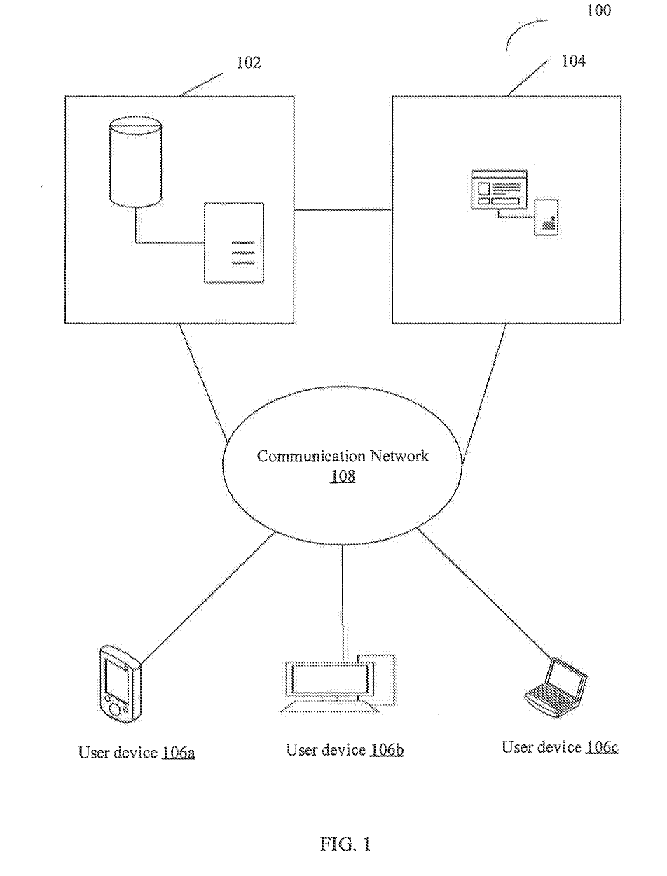

FIG. 1 is a block diagram that illustrates an exemplary environment 100 in which various embodiments of the present disclosure may function. The environment 100 may include a database server 102, a multimedia content recording system 104, a plurality of user devices 106 such as user device 106a, user device 106b, and user device 106c, and a communication network 108. The multimedia content recording system 104 may be communicatively coupled to the database server 102 and the user device 106 via the communication network 108. In an embodiment, the multimedia content recording system 104 may communicate with the database server 102 using one or more protocols such as, but not limited to, Open Database Connectivity (ODBC) protocol and Java Database Connectivity (JDBC) protocol.

In an embodiment, the database server 102 may refer to a computing device that may be configured to receive requests for multimedia content from the plurality of user devices (106a, 106b, 106c). In an embodiment, the database server 102 may include a special purpose operating system specifically configured to perform one or more predetermined database operations. The user may access the multimedia content from the database server 102 on various user devices. In an embodiment, the database server 102 may store copies of the multimedia content, update the multimedia content or delete the multimedia content. In an embodiment, the database server 102 may include hardware and/or software that may be configured to perform one or more predetermined operations. In an embodiment, the database server 102 may be realized through various technologies such as, but not limited to, Microsoft® SQL Server, Oracle®, IBM DB2®, Microsoft Access®, PostgreSQL®, MySQL® and SQLite®, and the like.

In an embodiment, the database server 102 may be configured to receive a request for multimedia content from one or more of user device 106a, user device 106b, or user device 106c. The plurality of user devices 106 may include computing devices or display devices used by a user. For example, user devices 106 may include a tablet, an LED television, a laptop computer, etc. On receiving the request, the database server 102 may provide the requested multimedia content to the requesting user device via the communication network 108. The communication network 108 although represented as one communication network in FIG. 1 may in reality correspond to different communication networks under different contexts. For example, the communication network 108 may be a mobile network through which a user device such as say, user device 106a may communicate with the database server 102. In another example, the communication network 108 may be a broadband network.

The communication network 108 may include various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G cellular communication protocols, and/or Bluetooth (BT) communication protocols. The communication network 108 may include, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

A user may access the database server 102 and may choose to record one or more content for future viewing. When the user selects a particular multimedia content to be recorded, the multimedia content recording system 104 may record multiple versions of the same multimedia content. This is generally done to cater to various user devices and networks through which the recorded multimedia content may potentially be consumed. The multimedia content recording system 104 may not be aware of the type of network, device and bit rate profile that would be requested by the client during playback of the recording and hence saves a number of versions of the same content at different bitrates. For example, if the user device requesting multimedia content is a smartphone connected to a mobile network, the multimedia content recording system 104 may record a lower quality version of the multimedia content taking into account the limited resources and slower network speeds associated with the smartphone that may potentially access the recording. Similarly, the multimedia content recording system 104 may also save a high quality version of the multimedia content in anticipation of a request from a client device that is connected to a broadband network. Since the broadband network can support higher bitrates and a request to view the recorded content may come from a device connected to a broadband network, the multimedia content recording system 104 may save a version at this higher bitrate to cater to such requests. Thus, the multimedia content recording system 104 may store different versions of the same video since the multimedia content recording system 104 may not know what user device or what network would be used to access the multimedia content from the multimedia content recording system 104.

The multimedia content recording system 104 may refer to a computing device or a software framework hosting an application or a software service. In an embodiment, the multimedia content recording system 104 may be implemented to execute procedures such as, but not limited to, programs, routines, or scripts stored in one or more memories for supporting the hosted application or the software service. In an embodiment, the hosted application or the software service may be configured to perform one or more predetermined operations. The multimedia content recording system 104 may be realized through various types of servers such as, but are not limited to, a Java application server, a .NET framework application server, a Base4 application server, a PHP framework application server, or any other application server framework.

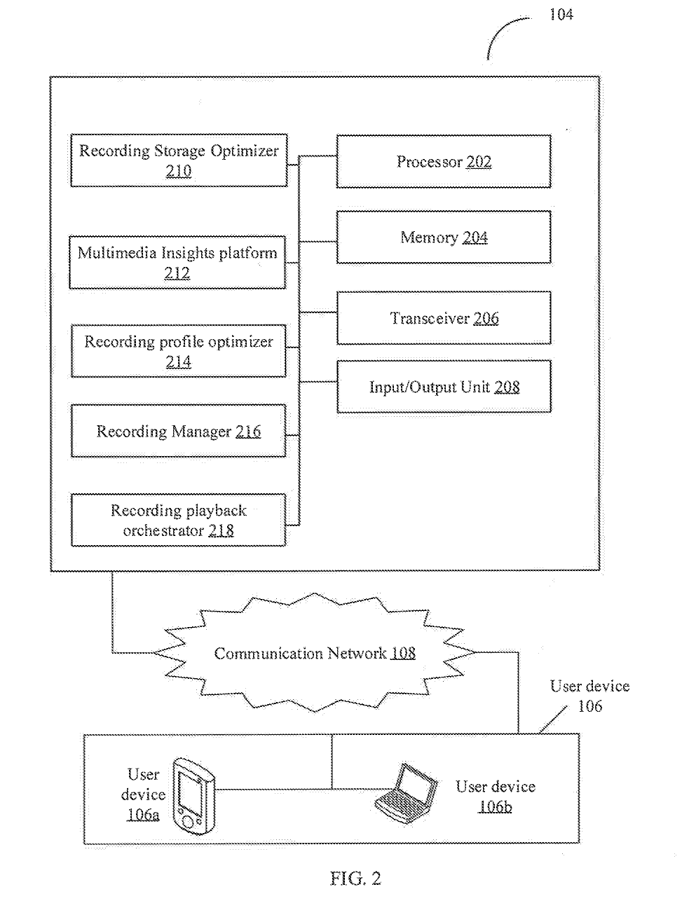

FIG. 2 is a block diagram that illustrates the multimedia content recording system 104 configured for a network based multimedia content recording in accordance with some embodiments of the present disclosure. The multimedia content recording system 104 may include a processor 202, a memory 204, a transceiver 206, and an input/output unit 208. The multimedia content recording system 104 may further include a recording storage optimizer unit 210, a multimedia index platform unit 212 a recording profile optimizer 214, a recording playback orchestrator 216 and a recording manager 218. The processor 202 may be communicatively coupled to the memory 204, the transceiver 206, and the input/output unit 208, the recording storage optimizer unit 210, the multimedia index platform unit 212, the recording profile optimizer 214, the recording manager 216 and the recording playback orchestrator 218.

The processor 202 may include suitable logic, circuitry, interfaces, and/or code that may be configured to execute a set of instructions stored in the memory 204. The processor 202 may be implemented based on a number of processor technologies known in the art. Examples of the processor 202 include, but not limited to, an X86-based processor, a Reduced Instruction Set Computing (RISC) processor, an Application-Specific Integrated Circuit (ASIC) processor, a Complex Instruction Set Computing (CISC) processor, and/or other processor.

The memory 204 may include suitable logic, circuitry, interfaces, and/or code that may be configured to store the set of instructions, which may be executed by the processor 202 for recording multimedia content. In an embodiment, the memory 204 may be configured to store one or more programs, routines, or scripts that may be executed in coordination with the processor 202. The memory 204 may be implemented based on a Random Access Memory (RAM), a Read-Only Memory (ROM), a Hard Disk Drive (HDD), a storage server, and/or a Secure Digital (SD) card.

The transceiver 206 may implement one or more known technologies to support wired or wireless communication with the communication network 106. In an embodiment, the transceiver 206 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 206 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.116b, IEEE 802.11g and/or IEEE 802.11n), voice over Internet Protocol (VoIP), Wi-MAX, a protocol for email, instant messaging, and/or Short Message Service (SMS).

The transceiver 206 may receive one or more recording requests for multimedia content from one or more users. A user may use a user device to request the multimedia content recording system 104 to record multimedia content. The multimedia content recording system 104, on receiving this request may communicate with a database server 102 such as that explained in conjunction with FIG. 1 to request for the multimedia content to be recorded. The one or more recording requests may include one or more attributes. Here, an ‘attribute’ in relation to the recording request may include a network attribute, a device attribute or a multimedia content attribute. A network attribute may correspond to a network from which the recording request originated. For example, if the recording request is received from a mobile device connected to a mobile network, then the network attributes may correspond to attributes of the mobile network such as type of mobile network, bitrate supported by the mobile network, latency of the mobile network, jitter of the mobile network, congestion of the mobile network, throughput of the mobile network, etc.

The device attributes associated with the recording request may include attributes of a user device from which the recording request was initiated, screen size of the user device, processing resources available at the user device, storage capacity of the user device, location of the user device, the type of user device, etc.

In addition to the network attributes and device attributes, the recording request may further include multimedia content attributes such as type of multimedia content, time of viewing the multimedia content, duration of the multimedia content, etc.

The Input/Output (I/O) unit 208 may include suitable logic, circuitry, interfaces, and/or code that may be configured to receive an input or transmit an output. The input/output unit 208 may include various input and output devices that are configured to communicate with the processor 202. Examples of the input devices include, but are not limited to, a keyboard, a mouse, a joystick, a touch screen, a microphone, and/or a docking station. Examples of the output devices include, but are not limited to, a display screen and/or a speaker.

Once the transceiver 206 receives the recording request, the recording storage optimizer unit 210 may be configured to determine one or more attribute values associated with the recording request. Here, an attribute value may correspond to a value of an attribute. For example, if an attribute associated with the recording request is “time of day”, then a corresponding attribute value may be “7 pm”. This indicates what time the recording request was initiated by the user. Similarly, for the attribute “type of mobile network”, a corresponding value may be “2G network” or “3G network”.

The recording storage optimizer unit 210 may determine all the relevant attribute values of the recording request and subsequently pass on these values to the recording profile optimizer unit 214. The recording profile optimizer unit 214 may compare the attribute values of the recording request with historical attribute values associated with a plurality of multimedia content previously viewed by the user. The historical attribute values associated with the plurality of multimedia content previously viewed by the user may be gathered and processed by the multimedia insights platform 212 to derive one or more insights about the viewing patterns of the user. For example, the multimedia insights platform 212 may determine from the past interactions of the user with multimedia content that the user watches short or comic videos around 8 am on a mobile device on most days. When the user subsequently initiates a recording request around this time, the multimedia insights platform 212 may determine that the user is most likely to consume the recorded content on the mobile device possibly the next day at around 8 am. Table 1 shows pattern of viewing multimedia contents for a day. The multimedia insights platform 212 may study such viewership details over a period of time, which may include a number of days.

TABLE 1

| | Frequently | | | | |
|---|---|---|---|---|---|
| | viewed | Frequently | | Cumulative | |
| Preferred | multimedia | used user | Preferred | time period of | Time of |
| bitrates | content type | device | network | viewing | viewing |
| 1 mbps | News | Tablet | 3G/4G | 15 minutes | 9 P.M |
| 10 mbps | TV Soaps | Laptop | Wi-fi | 60 minutes | 6 P.M |
| 50 mbps | War movies | LED Smart | Broad Band | 120 minutes | 10 P.M |
| | | TV | | | |

For example, the time period for studying the viewership pattern may be set by a service provider and may be for example be 30 days or in another case be 15 days. This attribute may take various values as per the standing instructions from the service operator. It may then be able to create the viewership patterns and create a data of historical attribute values associated with a plurality of multimedia content. For examples, type of multimedia content may take values like war movies, TV Soaps, news, while cumulative time period of viewing may be 60 minutes, 120 minutes.

When the recording profile optimizer unit 214 compares the attribute values of the recording request with historical attribute values, the recording profile optimizer unit 214 may essentially try to determine one or more past viewership patterns that the current recording request falls under. Based on identifying one or more patterns, the recording profile optimizer unit 214 along with inputs from the multimedia insights platform 212 may determine one or more preferred bitrates to use to record the multimedia content. For example, the multimedia insights platform 212 may determine that a user generally consumes short videos on a mobile device using a mobile network and longer videos at home on a TV connected to a broadband connection. When a recording request is received, the recording profile optimizer unit 214 may determine that the attribute value for the attribute “duration of multimedia content” for this particular recording request is “2 hours”. Based on consulting the multimedia insights platform 212, the recording profile optimizer unit 214 may determine that the user generally watches videos beyond 10 minutes long on a TV connected to a broadband network. In keeping with this insight, the recording profile optimizer unit 214 may determine the preferred bitrate for recording the video by considering that the user may most likely view this video on a TV and broadband connection rather than on a mobile using a mobile network. So, even if the recording request may be made on a mobile device, the preferred bitrate may be assumed to be that compliant with a TV connected to a broadband connection. In this way, the recording profile optimizer unit 214 may make assumptions as to which user device and what network may be used to access the recorded content and accordingly can only save the content in those bitrates which are most likely to be used instead of saving the content at all possible bitrates.

Similarly, the recording profile optimizer unit 214 may make one or more inferences based on the location of the user device from which the recording request originates. The multimedia insights platform 212 may determine, over a period of time, that the user is in one location between 9 am and 5 pm on weekdays. The multimedia insights platform 212 may infer that the user is at work and is most likely to consume multimedia content on a mobile device and not on a TV. With this insight, the recording profile optimizer unit 214 may provide the requested video only at a bitrate suitable for a mobile device on a mobile network during the hours of 9 am to 5 pm on weekdays. Thus, the recording profile optimizer unit 214 may make one or more inferences based on at least one of cognitive analysis and big data analysis.

Once it is known at what bit rate the multimedia content is suitable to be recorded, the recording manager unit 216 may record the multimedia content at the one or more preferred bit rates. The recording manager unit 216 may manage copies of multimedia content for each user who may have requested a recording. Once the multimedia content has been recorded, the user may access the multimedia content to view at a later point of time. This may be enabled by the recording playback orchestrator unit 218.

Once the recording manager unit 216 may record the multimedia content at the one or more preferred bit rates, the recording playback orchestrator unit 218 plays the multimedia content over the one or more preferred bitrates, in response to a request from the user. For example, if the user requests the recording of the multimedia content at attributes which is different from what is learnt by the multimedia insights platform 212, the recording manager unit 216 may record the multimedia content at a best possible bit rate supported by the environment the user is in.

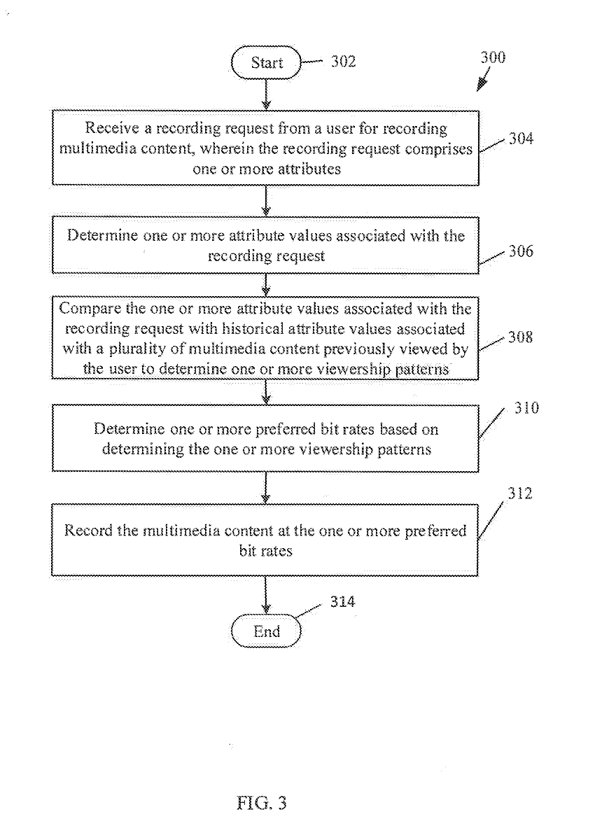

FIG. 3 is a flowchart illustrating a method 300 for network based multimedia content recording in a cloud. The method starts at 302. At step 304 the multimedia content recording system 104 is configured to receive a recording request from a user for recording multimedia content, wherein the recording request comprises one or more attributes. At step 306 the multimedia content recording system 104 is configured to determine one or more attribute values associated with the recording request. At step 308 the multimedia content recording system 104 is configured to compare the one or more attribute values associated with the recording request with historical attribute values associated with a plurality of multimedia content previously viewed by the user to determine one or more viewership patterns. At step 310 the multimedia content recording system 104 is configured to determine one or more preferred bit rates based on determining the one or more viewership patterns. At step 312 the multimedia content recording system 104 is configured to record the multimedia content at the one or more preferred bit rates. The control then passes to Step 314.

### Computer System

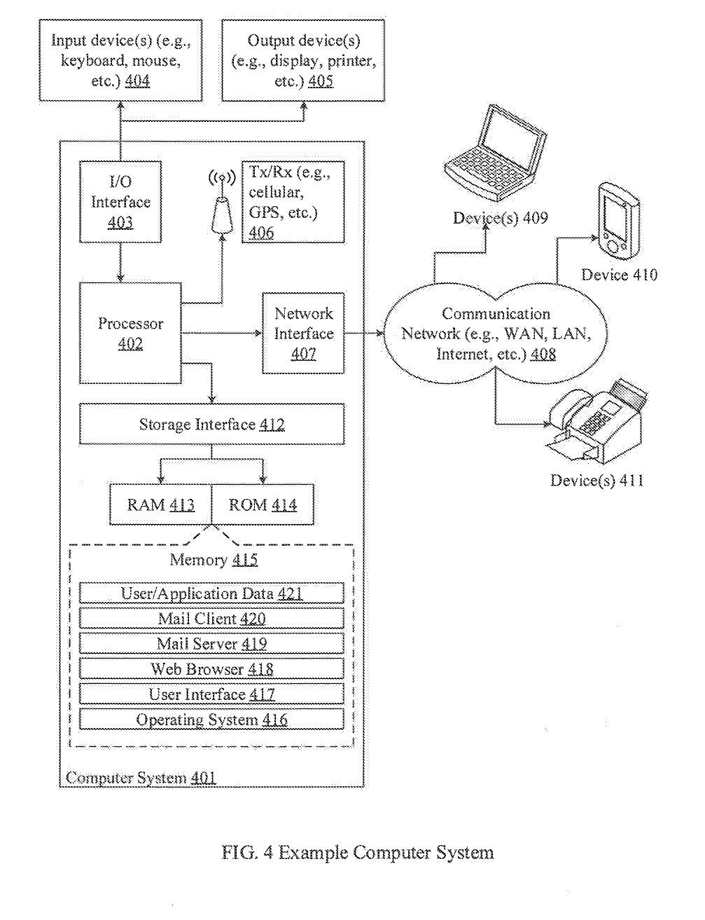

FIG. 4 illustrates a block diagram of an exemplary computer system for implementing embodiments consistent with the present disclosure. Variations of computer system 401 may be used for determining an effectiveness index of a software test environment. The computer system 401 may comprise a central processing unit (“CPU” or “processor”) 402. Processor 402 may comprise at least one data processor for executing program components for executing user or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon™, Duron or Opteron, ARM's application, embedded or secure processors, IBM PowerPC®, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM47501IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 402 may be disposed in communication with a communication network 408 via a network interface 407. The network interface 407 may communicate with the communication network 408. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 410, 411, and 412. These devices may include, without limitation, personal computer(s), server(s), fax machines, printers, scanners, various mobile devices such as cellular telephones, smartphones (e.g., Apple iPhone, Smart TV, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 402 may be disposed in communication with one or more memory devices (e.g., RAM 413, ROM 414, etc.) via a storage interface 412. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 416, user interface application 417, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat™, Ubuntu™, Kubuntu™, etc.), IBM OS/2™, Microsoft Windows™ (XP, Vista/7/8, etc.), Apple iOS®, Google Android™, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero™, Metro™, etc.), Unix X-Windows, web interface libraries (e.g., ActiveX, Java, Javascript, AJAX, HTML, Adobe Flash™, etc.), or the like.

In some embodiments, the computer system 401 may implement a web browser 418 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail, Microsoft Entourage, Microsoft Outlook, Mozilla Thunderbird, etc.

In some embodiments, computer system 401 may store user/application data 421, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc. and unstructured databases like Mongodh and distributed caches like Cassandra). Such databases may be consolidated or distributed, sometimes among the various computer systems discussed above in this disclosure. It is to be understood that the structure and operation of the any computer or database component may be combined, consolidated, or distributed in any working combination.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise. The terms “including”, “comprising”, “having” and variations thereof mean “including but not limited to”, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention. Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

### ADVANTAGES OF THIS INVENTION

The Present disclosure describes systems and methods related to a cloud-enabled network-based digital video recorder. It aims to address problems that are threatening the scaling of cloud DVR service across millions of subscribers by optimizing the storage space at the time of recording.

The present invention helps in significant reduction of cloud storage since only fewer video bit profiles are stored per unique copy. Highly personalized bit rate profiles storage based on watch patterns, guaranteeing better Video QoS considering non CDN based video streaming delivery.

The Present invention provides method of optimizing video storage on the cloud by analyzing the user's video consumption patterns and intelligently determining the most suitable video bitrate profile for storing the entire video on the cloud. This essentially means that for every video copy stored, the entire video is on a single bitrate. However, based on the result of analytics on the user's consumption patterns multiple profiles of the entire video might get stored, each on a different bitrate.

We claim:

1. A method of recording multimedia content, the method comprising:
receiving, by a multimedia content recording system, a recording request from a user for recording multimedia content, wherein the recording request comprises one or more attributes;
determining, by the multimedia content recording system, one or more attribute values associated with the recording request;
comparing, by the multimedia content recording system, the one or more attribute values associated with the recording request with historical attribute values associated with a plurality of multimedia content previously viewed by the user to determine one or more viewership patterns;
determining, by the multimedia content recording system, one or more preferred bit rates based on determining the one or more viewership patterns;
recording, by the multimedia content recording system, the multimedia content at the one or more preferred bit rates;

2. The method of claim 1, wherein the one or more attributes comprises at least one of network attributes, user device attributes, and multimedia content attributes.

3. The method of claim 2, wherein the network attributes comprises at least one of a bit rate supported by a network associated with the recording request and a signal strength of the network.

4. The method of claim 2, wherein the device attributes comprises a geo-location of a user device associated with the recording request and type of the user device associated with the recording request.

5. The method of claim 2, wherein the one or more multimedia content attributes comprises at least one of, type of multimedia content, time of viewing the multimedia content, and duration of the multimedia content.

6. The method of claim 1, wherein the one or more viewership patterns is determined based on at least one of cognitive analysis and big data analysis.

7. The method of claim 1, further comprising playing the recorded multimedia content at the one or more preferred bitrates, in response to a request from the user.

8. The method of claim 1, wherein the historical attribute values associated with the plurality of multimedia content previously viewed by the user is saved in a user profile associated with the user.

9. A multimedia content recording system for multimedia content recording, comprising:
a processor; and
a memory communicatively coupled to the processor, wherein the memory stores processor instructions, which, on execution, causes the processor to:
receive a recording request from a user for recording multimedia content, wherein the recording request comprises one or more attributes;
determine one or more attribute values associated with the recording request;
compare the one or more attribute values associated with the recording request with historical attribute values associated with a plurality of multimedia content previously viewed by the user to determine one or more viewership patterns;
determine one or more preferred bit rates based on determining the one or more viewership patterns; and
record the multimedia content at the one or more preferred bit rates.

10. The method of claim 9, wherein the one or more attributes comprises at least one of network attributes, user device attributes and multimedia content attributes.

11. The method of claim 10, wherein the network attributes comprises at least one type of mobile network, bitrate supported by the mobile network, latency of the mobile network, jitter of the mobile network, congestion of the mobile network, throughput of the mobile network.

12. The method of claim 10, wherein the device attributes comprises a geo-location of a user device associated with the recording request and type of the user device associated with the recording request.

13. The method of claim 9, wherein the one or more multimedia content attributes comprises at least one of, type of multimedia content, time of viewing the multimedia content, and duration of the multimedia content.

14. The method of claim 9, wherein the one or more viewership patterns is determined based on at least one of cognitive analysis and big data analysis.

15. The method of claim 9, further comprising playing the recorded multimedia content at the one or more preferred bitrates, in response to a request from the user.

16. A non-transitory computer-readable storage medium having stored thereon, a set of computer-executable instructions for causing a computer comprising one or more processors to perform steps comprising:
receiving a recording request for recording multimedia content from a user, wherein the recording request comprises one or more attributes;
determining one or more attribute values associated with the recording request;
comparing the one or more attribute values associated with the recording request with historical attribute values associated with a plurality of multimedia content previously viewed by the user to determine one or more viewership patterns;
determining one or more preferred bit rates based on determining the one or more viewership patterns; and
recording the multimedia content at the one or more preferred bit rates.
